(19) United States
(12) Patent Application Publication
(10) Pub. No.: US 2016/0379615 A1
(43) Pub. Date: Dec. 29, 2016

(54) ACOUSTIC DAMPING COMPOSITION

(71) Applicant: HENKEL AG & CO. KGAA, Duesseldorf (DE)

(72) Inventors: Huimin BAO, Shanghai (CN); Qi Chen, Shanghai (CN); Yew-Guan Low, Shanghai (CN); Shuchang Xue, Shanghai (CN)

(21) Appl. No.: 15/258,254

(22) Filed: Sep. 7, 2016

Related U.S. Application Data
(63) Continuation of application No. PCT/CN2014/073147, filed on Mar. 10, 2014.

(51) Int. Cl. G10K 11/162; C08L 57/02

(52) U.S. Cl. CPC G10K 11/162; C08L 57/02

(57) ABSTRACT

The present invention provides an acoustic damping composition comprising a propylene-based polyolefin, a tackifier, a filler and a stabilizer, wherein the density of the propylene-based polyolefin is in the range of 0.8 to 1.2 g/m³, preferably 0.8 to 1.0 g/m³, measured according to ASTM D1505, and the propylene content in the propylene-based polyolefin is more than 50 wt %, preferably more than 60 wt %, more preferably more than 70 mol %.

### FIELD OF THE INVENTION

The present invention relates to an acoustic damping composition, in particular an acoustic damping composition comprising a polyolefin component. This invention also relates to the use of the acoustic damping composition in acoustic damping, preferably acoustic damping in car bodies.

### BACKGROUND OF THE INVENTION

Acoustic damping materials are widely used in transportation, appliances and constructions to reduce noise, vibration and harshness. In the automotive field, interior floor pans, roofs and doors of a car need damping materials to decrease structure-borne noise that can be transmitted through car-body substrates. Materials with good damping performance, low density and low volatile-organic-compound (VOC) release at the application temperature are highly appreciated in the automotive industry.

According to the application methods in car bodies, there are two kinds of damping materials. One kind of damping material is pre-cut pieces of melt pads which are made of asphaltic materials, butylene rubbers or pressure sensitive adhesives (PSA). The other kind of damping material is sprayable coatings which are also referred to as liquid applied sound deadeners.

US 2009/0127490 A1 discloses a sound deadener melt pad composition including specific amounts of asphalt, acetate, a fiber, lime and an olein.

U.S. Pat No. 7,230,041B2 discloses a bituminous composition, which can be used for sound deadening, comprising a bituminous component and a specific block copolymer.

US 005260367 A discloses a vehicle damping sheet applicable to floors and dash panels comprising a blend-mixture comprising a filler (composed of mica, iron oxide particles and an auxiliary filler) and a specific binder. It is alleged that a damping sheet with light-weight and high damping effect within a wide temperature range can be obtained. However, there is no density data showing its light-weight characteristic.

Besides those pre-cut asphalt or rubber based patches, EP 1741759 B1 discloses a water-based coating-type vibration damping material.

WO 2008/002842 A1 discloses a method of applying a specific damping and/or aesthetic coating.

For pre-cut melt sheets, a lot of efforts are needed to cut a melt sheet into pieces with different sizes and shapes and then manually post those pieces onto substrates, while sprayable coating can be labor saving by using robotics. However, the huge investment for spray machines is always a big limitation. Therefore, the melt sheets still take a main market share so far.

Nowadays, there are more and more demands from vehicle makers for lighter weight, less odor and environmental-friendly materials to be used in car acoustics, which raises challenges for asphaltic and butylene rubber melt sheets.

### SUMMARY OF THE INVENTION

It is an object of the present invention to provide an improved acoustic damping material, which, e.g., has a good damping performance, a lower density, less odor and/or less VOC release. This object of the invention is achieved by an acoustic damping composition comprising, preferably substantially comprising, more preferably is composed of a propylene-based polyolefin, a tackifier, a filler and a stabilizer, wherein the density of the propylene-based polyolefin is in the range of 0.8 to 1.2 g/m³, preferably of 0.8 to 1.0 g/m³, measured according to ASTM D1505, and the propylene content in the propylene-based polyolefin is more than 50 wt %, preferably more than 60 wt % and more preferably more than 70 wt %.

The term “substantially comprising” used herein should be understood as that the listed components in the claims, including the optional ones, constitute the main part of the composition, for example, above 80%, preferably above 90%, more preferably above 95%, or most preferably above 97% by weight of the composition and beside them, one or more conventional additives or components may be included. According to practical requirements, a small amount of asphalt, EVA(s), butylene rubber(s) and/or styrene block polymer(s) may also be added to the acoustic damping composition of the present invention.

The term “polyolefin” used herein refers to any of a class of polymers produced from olefin(s) (also referred to as alkene with the general formula CₙH₂ₙ) as monomer(s), and said polymers include homopolymers and copolymers. The term “polyolefin” is also known as polyalkene. For example, polypropylene is a polyolefin which is made from a simple olefin, i.e., propylene.

The term “propylene-based polyolefin” used herein refers to polymers produced from simple propylene monomers or from propylene monomers and other olefin monomer(s) with a propylene monomer content of more than 50 wt %, preferably more than 60 wt %, more preferably more than 70 wt %.

Preferably, the acoustic damping composition of the present invention is essentially free of asphalt, EVA(s), butylene rubber(s) and styrene block polymer(s).

The term “essentially free” used herein refers to an amount of less than 3 wt %, preferably less than 2 wt %, more preferably less than 1 wt % and most preferably 0 wt % of the composition.

In an embodiment of the invention, the acoustic damping composition comprises about 10-80 wt %, preferably 10-60 wt %, more preferably 15-35 wt % of the propylene-based polyolefin, based on the total weight of the composition.

### DETAILED DESCRIPTION OF THE INVENTION

The present invention will be described in details as follows. The materials, methods, and examples herein are illustrative only and, except when specifically stated otherwise, are not intended to be limiting. Suitable methods and materials are described herein, although methods and materials similar or equivalent to those described herein can be used in the practice or testing of the present invention.

All publications and other references mentioned herein are explicitly incorporated by reference in their entirety.

Unless otherwise defined, all technical and scientific terms used herein have the same meanings as commonly understood by those skilled in the art. In case of conflict, the present specification, including definitions, is decisive.

Unless stated otherwise, all percentages, parts, ratios, etc., are by weight.

Where a range of numerical values are recited herein, unless stated otherwise, the range is intended to include the endpoints thereof, and all integers and fractions within the range.

Use of “a” or “an” is employed to describe elements and components of the present invention. This is done merely for convenience and to give a general sense of the invention. This description should be read to include by “one” also “at least one” and the singular also includes the plural unless it is obvious that it is meant otherwise.

Other than in the operating examples, or where otherwise indicated, all numbers expressing quantities of ingredients, reaction conditions, or defining ingredient parameters used herein are to be understood as modified in all instances by the term “about”.

The term “room temperature (RT)” used herein refers to around 25° C.

The term “copolymer” or similar terms used herein should be understood as a polymer derived from two or more monomers, that is to say, the term “copolymer” includes bipolymers, terpolymers, tetrapolymers and so on.

Each component in the composition of the present invention will be described in detail below.

Propylene-Based Polyolefin

One or more propylene-based polyolefins may be comprised in the acoustic damping composition of the invention. The density of the propylene-based polyolefin(s) is in the range of 0.8 to 1.2 g/m³, preferably 0.8 to 1.0 g/m³, measured according to ASTM D1505. The propylene content in the propylene-based polyolefin(s) is more than 50 wt %, preferably more than 60 wt %, more preferably more than 70 wt %.

In an embodiment of the invention, the propylene-based polyolefin comprises, preferably substantially comprises or more preferably is composed of a propylene-based elastomer, and optionally a propylene-based amorphous poly-a-olefin (APAO) and/or a propylene-based plastomer.

The total amount of the propylene-based polyolefin in the acoustic damping composition of the invention may be 10 to 80 wt %, preferably 10 to 60 wt %, or more preferably 15 to 35 wt %, based on the total weight of the composition.

Propylene-Based Elastomer

The propylene-based elastomers suitable of the present invention preferably have a Melt Flow Rate (MFR) of below 100 g/10 min, more preferably below 50 g/10 min, measured at 230° C./2.16 kg according to ASTM D1238, a density of below 0.88 g/m³ measured according to ASTM D1505, and a enthalphy of fusion of less than 10 J/g, more preferably less than 5 J/g, measured by Differential Scanning Calorimetry.

The enthalphy of fusion of the present invention can be measured by Differential Scanning Calorimetors conventionally used in the art, such as, Q 2000 from TA instruments-Waters LLC.

The enthalphy of fusion of the present invention, for example, can be measured in a temperature range of −50° C. to 200° C. with a heating rate of 10° C./min and a cooling rate of −10° C./min, and by taking the enthalphy of fusion of the second heating curve.

The propylene-based elastomer is also referred to as “the elastomer” in the present invention. Preferably, the propylene-based elastomers are metallocene-catalyzed polymers. “Metallocene-catalyzed polymers” or similar terms used herein should be understood as any polymers that are made in the presence of a metallocene catalyst. The propylene content in the propylene-based elastomers preferably is more than 50 wt %, preferably more than 70 wt %, or more preferably more than 80 wt %. Exemplary polymers and preparation methods are disclosed, e.g., in US 2014/0038486 A1, which are hereby incorporated by reference.

Preferably, the propylene-based elastomers used in the acoustic damping composition of the present invention include but are not limited to propylene copolymers where the one or more comonomers is/are selected from ethylene, butene, hexylene and octene and combinations thereof. More preferably, the propylene-based elastomers include but are not limited to propylene-ethylene copolymers or propylene-ethylene-butene terpolymers.

Examples of commercially available products of the propylene-based elastomers include but are not limited to VISTAMAXX™ series products from ExxonMobil Chemical and VERSIFY™ series from Dow Chemical.

The acoustic damping composition of the invention may comprise one or more propylene-based elastomers as described above. The amount of the propylene-based elastomer(s) in the acoustic damping composition of the invention may be 5-80 wt %, preferably 5 to 50 wt %, more preferably 10 to 30 wt %, based on the total weight of the composition.

APAO

The amorphous poly-α-olefins (APAOs) suitable for the present invention comprise several different categories of atactic, low molecular weight, low melt viscosity, and essentially amorphous propylene based polymers, which are typically polymerized by means of processes which employ a Ziegler-Natta catalyst, in generally resulting in a relatively broad molecule weight distribution (Mw/Mn), typically greater than 4. These polymers are well known to those skilled in the art and can preferably be either homopolymers of propylene or copolymers of propylene with one or more a-olefinic comonomer, preferably selected from C2-C8 α-olefins, more preferably ethylene, 1-butene, 1-hexylene and 1-ocetene or combinations thereof.

The weight average molecular weight of the APAO(s) used in the present invention is preferably in the range of no less than 1000 g/mol, more preferably in a range having any lower limit of 1,000, 2,000, 3,000, 4,000 or 5,000 g/mol in combination with any upper limit of 100,000, 90,000, 80,000 or 50,000 g/mol, most preferably 1,000 to 100,000 g/mol. APAO grades with higher weight average molecular weight than 100,000 g/mol can also be used according to practical requirement.

The APAOs have advantageously a ring and ball softening point between 80° C. and 170° C. and a glass transition temperature from −5° C. to −40° C. and a MFR value of more than 1000 g/10 min measured at 230° C./2.16 kg according to ASTM D1238.

Examples of commercially available products of the propylene-based APAO include but are not limited to VESTOPLAST® series products from Evonik, REXTAC® series products from Huntsman, EASTOFLEX™ from Eastman.

It is not necessary for the APAO(s) to be present in the acoustic damping composition of the present invention. However, if desired, the acoustic damping composition of the invention may comprise one or more APAOs as described above.

The amount of the APAO(s) in the acoustic damping composition of the invention may be 0 to 60 wt %, preferably 5 to 40 wt %, more preferably 5 to 30 wt %, most preferably 10 to 20 wt %, based on the total weight of the composition.

Propylene-Based Plastomer

The propylene-based plastomers suitable for the acoustic damping composition of the invention preferably have a density greater than 0.88 g/m³, more preferably >0.88 to 1.0 g/m³, measured according to ASTM D1505, and a enthalphy of fusion of more than 10 J/g, more preferably more than 15 J/g, measured by Differential Scanning Calorimetry.

The test method for the enthalphy of fusion of the plastomers is the same as the above test method for the enthalphy of fusion of the elastomers.

The propylene-based plastomer is also referred to as “the plastomer” in the present invention. Examples of the plastomers used herein include polypropylene homopolymers or copolymers wherein the propylene monomer constitutes more than 50 wt %, preferably more than 70 wt %, more preferably more than 80 wt % and the one or more comonomers is/are selected from ethylene, butene, hexylene and octene or a combination thereof. Optionally, in the molecular backbone of the plastomer, one or more functional groups, for example acrylic acid, acetate, sulfonate, maleic anhydride, fumaric acid and others can be included, preferably maleic anhydride is included.

Examples of commercially available products of the propylene-based plastomers include all the propylene homopolymers or random copolymer grades usable for film application and injection molding, and the suppliers include but are not limited to LyondellBasell, Borealis, Mitsui, ExxonMobil, Dow Chemical, Formosa, LG chemical, Sabic, Lotte Chemical, SK and others. The functionalized propylene-based homopolymer/copolymer grades include but are not limited to EXXELOR™ series product from ExxonMobil Chemical; OREVAC® series from Arkema, and BONDYRAM® from Polyram.

It is not necessary for the plastomer(s) to be present in the acoustic damping composition of the present invention. However, if desired, the composition of the invention may comprise one or more propylene-based plastomers described above.

The amount of the plastomer in the acoustic damping composition of the invention may be 0 to 40 wt. %, preferably 1 to 30 wt. %, more preferably 1 to 20 wt. %, most preferably 5 to 10 wt. % based on the total weight of the composition.

Tackifier

The acoustic damping composition of the invention may comprise one or more tackifier.

Examples of those tackifiers include: aliphatic petroleum hydrocarbon resins, alicyclic petroleum hydrocarbon resins, modified hydrocarbons and hydrogenated derivatives thereof. The modified hydrocarbons are resulting from the polymerization of monomers consisting primarily of olefins or diolefins, which are optionally grafted with one or more functional groups like maleic anhydride. The olefins or diolefins are preferably selected from piperylene, isoprene, dicyclopentadiene or 2-methyl-2-butene. A combination of these tackifier types can also be used. These tackifiers have preferably a ring and ball softening point from 70° C. to 150° C. (according to ASTM E 28).

Examples of commercially available products of the tackifier include but are not limited to I Mary P 100, I Mary S 100, I Mary S 110, I Mary P 125, I Mary P 140 from Idemitsu, SU 100, SU 100S, SU110, SU120, SU130, SU 400, SU 420, SU500, SU 525, R 1100S, A 1100S from Kolon, Eastotac C-100W, C 115W, H 100W, H 115W, H130W, H142W, C-100R, H130R, H142R, Reglite R1100, Reglite R1125 from Eastman and Luhorez A-1100S, A 1100, A 2100 from Qilu Yixi Luhua Chemical Co., Ltd.

The amount of the tackifier(s) in the composition of the invention can be 10 to 50 wt. %, preferably 20 to 45 wt. %, more preferably 20 to 40 wt % and most preferably 25 to 40 wt % based on the total weight of the composition.

Filler

One or more fillers known in the art may be included in the acoustic damping composition of the invention. Examples include but are not limited to graphite, mica, calcium carbonate, barium sulfate, all kinds of fiber fillers and magnetic fillers or combinations thereof. As to the fiber fillers mentioned, they can include waste paper fibers, glass fibers, chemical fibers, wood fibers, natural fibers, etc. The magnetic fillers can be used to increase the adhesion to metal substrates, and all iron oxide particles, such as FeOOH particles, FeO particles, Fe₂O₃ particles, Fe₃O₄ particles and sintered particles thereof, as well as spinel ferrite particles containing metal(s) such as Zn, Mn, Co, Ni, Cu, Mg and Li., They can be used alone or as a mixture thereof.

The amount of the filler in the composition of the invention can be 5 to 70 wt. %, preferably 10 to 70 wt. % more preferably 15 to 70 wt. %, most preferably 15 to 45 wt. % based on the total weight of the composition.

Stabilizer

The acoustic damping composition of the invention may further contain conventional additives such as stabilizers according to practical requirements. In the present invention, the term “stabilizer” has the same meaning as the term “antioxidant” and they can be used interchangeably.

Stabilizers utilized herein include hindered phenol and multifunctional phenols such as sulfur- and phosphorous-containing phenols. Hindered phenols are well known in the art and may be characterized as phenolic compounds which also contain sterically bulky radicals in close proximity to the phenolic hydroxyl group thereof. In particular, tertiary butyl groups generally are introduced through substitution in the benzene ring in at least one of the ortho positions relative to phenolic hydroxyl group thereof. The presence of these sterically bulky substituted radicals in the vicinity of the hydroxyl group serves to retard its stretching frequency and correspondingly its reactivity. Thus, this steric hindrance provides the phenolic compound with its stabilizing properties. Representative hindered phenols include 1,3,5-trimethyl-2,4,6-tris(3,5-ditert-butyl-4-hydroxybenzyl)benzene, pentaerythrityl tetrakis-3(3,5-ditert-butyl-4-hydroxybenzyl)propionate, n-octadecyl-3(3,5-ditert-butyl-4-hydroxybenzyl)propionate, 4,4′-methylene bis(2,6-tert-butylphenol), 4,4′-thiobis-(6-tert-butyl-o-cresol), 2,6-tert-butylphenol, 6-(4-hydroxyphenoxy)2,4-bis(n-octyl-thio)-1,3,5-triazine, di-n-octadecyl 3,5-ditert-butyl-4-hydroxy-benzylphosphonate, 2-(n-octylthio)ethyl 3,5-di-tert-butyl-4-hydroxy-benzoate and sorbitol hexa([3-(3,5-ditert-butyl-4-hydroxylphenyl)-propionate].

The acoustic damping composition of the invention may comprise one or more stabilizers known in the art.

Examples of commercially available stabilizers include but are not limited to IRGANOX® 1010, IRGANOX® 1076 and IRGAFOS® 168 from BASF.

The amount of the stabilizer in the acoustic damping composition of the invention may be 0.01 to 10 wt %, preferably 0.1 to 5 wt %, more preferably 0.5 to 1 wt % based on the total weight of the composition.

### EXAMPLES

The present invention will be further described and illustrated in detail with reference to the following examples which, however, are not intended to restrict the scope of the present invention. All numbers in the examples are expressed in parts by weight, except for the CLF values and the density values.

Materials Used in the Examples
VISTAMAXX 6202 is a propylene-based elastomer from ExxonMobil Chemical, having a density of 0.861 g/m³ (ASTM D1505) and a MFR value at 230° C./2.16 kg of 18 g/10 min (ASTM D1238), and the ethylene content thereof being 15% by weight.
VESTOPLAST 703 is an APAO from Evonik, having a molecular weight (Mw) of 34,000 g/mol, a Brookfield viscosity at 190° C. of 2000-3400 cps and density of 0.87 g/cm³ at 23° C.
EXXELOR™ PO 1020 is a maleic anhydride functionalized polypropylene from ExxonMobil.
SABIC® PP 579S is a propylene homopolymer from Sabic, having a density of 0.905 g/m³ (according to ASTM D792) and a MFR value at 230° C./2.16 kg of 47 g/10 min (according to ASTM D1238).
Hikorez R-1100S is a petroleum hydrocarbon resin from Kolon Chemical.
EASTOTAC C 100R is a petroleum hydrocarbon resin with a ring and ball softening point of 100° C. (according to ASTM E 28) and a molten Gardner color of 4, from Eastman.
I Mary P100, P125 and P140 are hydrogenated petroleum hydrocarbon resin from Idemitsu, and their ring and ball softening points are 100° C., 125° C. and 140° C. (according to ASTM E 28) respectively.
IRGANOX 1010 is an antioxidant from BASF.

Test Methods

Damping Loss Factor

The damping loss factor was determined according to the standard test method ASTM E765-05 and denoted as CLF (composite loss factor). The damping loss factor at 200 Hz was obtained through the interpolation between the 2^{nd} and 3^{rd} order frequency damping ratio following the method in SAE J1637-07.

The length of the substrate metal bar was 240 mm, the thickness of the substrate metal bar was 1 mm and the width of the substrate metal bar was 10 mm. The sample length on top of the substrate was 216 mm. All The samples thickness were 2.5 mm and all the samples width were 10 mm.

Density

Mettler Toledo XS 204 was used for density test of the acoustic damping materials under room temperature. ASTM D792 08 (Standard Test Methods for Density and Specific Gravity of Plastics by Displacement) was followed during the density testing.

### Examples 1 to 4

Acoustic damping materials 1 to 4 were prepared using the components shown in Table 1.

The preparation processes of acoustic damping materials 1 to 4 are the same and are illustrated by the preparation process for the acoustic damping material 1.

Firstly, all components of Example 1 as listed in Table 1 were weighted and mixed in the Z-blade mixer, then were poured out and put onto a hot presser, on which the composition was pressed into a sheet with a thickness of 2.5 mm at 140° C. for 1 min, under pressure of 1000 kgf.

Various performances were tested according to the above methods and the results are also shown in Table 1.

TABLE 1

| | Ex. | Ex. | Ex. | Ex. | Bitu- | Bitu- |
|---|---|---|---|---|---|---|
| Components | 1 | 2 | 3 | 4 | men 1 | men 2 |
| VISTAMAXX 6202 | 15 | 15 | 10 | 25 | | |
| (Elastomer) | | | | | | |
| VESTOPLAST 703 | 15 | 15 | 10 | | | |
| (APAO) | | | | | | |
| EXXELOR PO 1020 | | | 5 | | | |
| (Plastomer) | | | | | | |
| SABIC ® PP 579S | | | 5 | | | |
| (Plastomer) | | | | | | |
| Hikorez R 1100S | 40 | 25 | 30 | 30 | | |
| (Tackifier) | | | | | | |
| Graphite (Filler) | 15 | 45 | 40 | 45 | | |
| BaSO₄(Filler) | 15 | | | | | |
| IRGANOX 1010 | 0.6 | 0.6 | 0.6 | 0.6 | | |
| (Antioxidant) | | | | | | |
| 200 Hz CLF @ RT | 0.15 | 0.20 | 0.15 | 0.18 | 0.15 | 0.14 |
| Density @ RT (g/ml) | 1.13 | 1.2 | 1.2 | 1.2 | 1.86 | 1.67 |

In Table 1, Bitumen 1 and Bitumen 2 are conventional bituminous products from the market. It can be seen from Table 1 that acoustic damping materials 1 to 4 of the invention show a good damping property. The materials of the present invention have a loss factor at room temperature of above 0.1 and a density at room temperature of around 1.2 which means at least 25% weight saving compared to conventional bituminous sheets.

### Examples 5 to 7

Examples 5-7, shown in Table 2, are designed to study the influence of the filler content on the damping performance and density. The preparation processes of acoustic damping materials 5 to 7 are the same as that of acoustic damping material 1. It can be seen from Table 2 that as the graphite content increases, the CLF value increases accordingly.

TABLE 2

| Components | Ex. 5 | Ex. 6 | Ex. 7 |
|---|---|---|---|
| VISTAMAXX 6202 (Elastomer) | 10 | 10 | 10 |
| VESTOPLAST 703 (APAO) | 15 | 15 | 15 |
| SABIC ® PP 579S (Plastomer) | 5 | 5 | 5 |
| Hikorez R 1100S (Tackifier) | 40 | 35 | 30 |
| Graphite (Filler) | 30 | 35 | 40 |
| IRGANOX 1010 (Antioxidant) | 0.6 | 0.6 | 0.9 |
| 200 Hz CLF @ RT | 0.11 | 0.12 | 0.19 |
| Density @ RT (g/ml) | 1.2 | 1.2 | 1.25 |

### Examples 8a and 8b

Examples 8a and 8b, shown in Table 3, are designed to study the influence of the filler type on the damping performance and density. The preparation processes of the acoustic damping materials 8a and 8b are the same as that of acoustic damping material 1. Results show that graphite and mica both lead to a good acoustic damping performance.

TABLE 3

| Components | Ex. 8a | Ex. 8b |
|---|---|---|
| Vistamaxx 6202 (Elastomer) | 10 | 10 |
| Vestoplast 703 (APAO) | 15 | 15 |
| Sabic ® PP 579S (Plastomer) | 5 | 5 |
| Hikorez R 1100S (Tackifier) | 40 | 40 |
| Graphite (Filler) | 30 | |
| Mica (Filler) | | 30 |
| Irganox 1010 (Antioxidant) | 0.6 | 0.6 |
| 200 Hz CLF @ RT | 0.16 | 0.15 |
| Density @ RT (g/ml) | 1.12 | 1.12 |

### Examples 9 to 13

Acoustic damping materials 9 to 13 were prepared using the components shown in Table 4. The preparation processes of acoustic damping materials 9 to 13 are the same as that of acoustic damping material 1. Various performances were tested according to the above methods and the results are shown in Table 4. The densities of Ex. 9 to Ex. 13 are all the same, which is 1.2 g/ml at room temperature.

TABLE 4

| Components | Ex. 9 | Ex. 10 | Ex. 11 | Ex. 12 | Ex. 13 |
|---|---|---|---|---|---|
| Vistamaxx 6202 | 15 | 15 | 15 | 15 | 15 |
| (Elastomer) | | | | | |
| Vestoplast 703 (APAO) | 15 | 15 | 15 | 15 | 15 |
| Sabic ® PP 579S | 5 | 5 | 5 | 5 | 5 |
| (Plastomer) | | | | | |
| Graphite (Filler) | 40 | 40 | 40 | 40 | 40 |
| Hikorez R 1100S | 25 | | | | |
| (Tackifier) | | | | | |
| Eastotac C 100R (Tackifier) | | 25 | | | |
| I Marv P 100 (Tackifier) | | | 25 | | |
| I Marv P 125 (Tackifier) | | | | 25 | |
| I Marv P 140 (Tackifier) | | | | | 25 |
| Irganox 1010 (Antioxidant) | 0.6 | 0.6 | 0.6 | 0.6 | 0.6 |
| 200 Hz CLF @ RT | 0.20 | 0.17 | 0.25 | 0.20 | 0.15 |

In acoustic damping materials 9 to 13, different tackifiers were contained. It can be seen from Table 4 that all acoustic damping materials 9 to 13 of the invention show a good damping property.

The present invention is illustrated in detail in the embodiments. However, it is apparent for those skilled in the art to modify and change the embodiments without deviating from the spirit of the invention. All the modifications and changes should fall within the scope of the appended claims of the present application.

1: An acoustic damping composition comprising a propylene-based polyolefin, a tackifier, a filler and a stabilizer, wherein the density of the propylene-based polyolefin is in the range of 0.8 to 1.2 g/m³, preferably 0.8 to 1.0 g/m³, measured according to ASTM D1505, and the propylene content in the propylene-based polyolefin is more than 50 wt %, preferably more than 60 wt %, more preferably more than 70 wt %.

2: The acoustic damping composition according to claim 1, wherein the propylene-based polyolefin comprises a propylene-based elastomer, and optionally a propylene-based amorphous poly-α-olefin and/or a propylene-based plastomer, wherein the propylene-based elastomer has a Melt Flow Rate (MFR) of below 100 g/10 min, preferably below 50 g/10 min, measured at 230° C./2.16 kg according to ASTM D1238 and a density of below 0.88 g/m³ measured according to ASTM D1505.

3: The acoustic damping composition according to claim 2, wherein the amorphous poly-α-olefin has a weight average molecular weight of no less than 1,000 g/mol, preferably 1,000 to 100,000 g/mol.

4: The acoustic damping composition according to claim 2, wherein the propylene-based plastomer has a density of greater than 0.88 g/m³, preferably >0.88 to 1.0 g/m³, measured according to ASTM D1505.

5: The acoustic damping composition according to claim 2, wherein the propylene-based elastomer is a metallocene-catalyzed elastomer.

6: The acoustic damping composition according to claim 2, wherein the propylene-based elastomer is selected from propylene copolymers where the one or more comonomers are selected from ethylene, butene, hexylene and octene or combinations thereof.

7: The acoustic damping composition according to claim 2, wherein the amorphous poly-α-olefin is selected from the group of propylene copolymers where the one or more comonomers are selected from ethylene, 1-butene, 1-hexylene and 1-octene or combinations thereof.

8: The acoustic damping composition according to claim 2, wherein the propylene-based plastomer is a propylene homopolymer or a copolymer of propylene monomers with one or more comonomers selected from ethylene, butene, hexylene and octene or combinations thereof.

9: The acoustic damping composition according to claim 2, wherein one or more functional groups selected from acrylic acid, acetate, sulfonate, maleic anhydride, fumaric acid and combinations thereof are included in the molecular backbone of the plastomer.

10: The acoustic damping composition according to claim 1, wherein the at least one filler is selected from the group consisting of graphite, mica, calcium carbonate, barium sulfate, fiber fillers and magnetic particles or combinations thereof.

11: The acoustic damping composition according to claim 1, wherein the propylene-based polyolefin is present in the composition in a total amount of 10 to 80 wt %, preferably 10 to 60 wt. %, more preferably 15 to 35 wt. %, based on the total weight of the composition.

12: The acoustic damping composition according to claim 1, wherein the filler is present in the composition in an amount of 5 to 70 wt %, preferably 15 to 70 wt %, more preferably 15 to 45 wt. % based on the total weight of the composition.

13: The acoustic damping composition according to claim 1, wherein the tackifier is present in the composition in an amount of 10 to 50 wt %, preferably 20 to 40 wt %, based on the total weight of the composition.

14. (canceled)

15: An article comprising the acoustic damping composition according to claim 1.
